(19) United States
(12) Patent Application Publication
(10) Pub. No.: US 2018/0376467 A1
(43) Pub. Date: Dec. 27, 2018

(54) EXTENSION OF BEACON REQUEST/REPORT MECHANISM FOR SPATIAL REUSE

(71) Applicant: QUALCOMM Incorporated, San Diego, CA (US)

(72) Inventors: Abhishek Pramod PATIL, San Diego, CA (US); Alfred ASTERJADHI, San Diego, CA (US); George CHERIAN, San Diego, CA (US)

(21) Appl. No.: 16/013,649

(22) Filed: Jun. 20, 2018

Related U.S. Application Data
(60) Provisional application No. 62/525,055, filed on Jun. 26, 2017.

(51) Int. Cl. H04W 72/04; H04W 16/06; H04W 64/00

(52) U.S. Cl. CPC H04W 72/046; H04W 16/06; H04W 84/12; H04W 64/003; H04W 72/0426

(57) ABSTRACT

Techniques are provided for extending a beacon request mechanism in IEEE 802.11k for spatial reuse. Particularly, in order to facilitate spatial reuse, features of the present disclosure allow an access point (e.g., a high efficiency access point or HE AP) to request information regarding neighboring APs from one or more associated STAs such that the AP may determine whether any of the neighboring APs are part of the same enterprise or spatial reuse group (SRG) as the AP based on the basic service set (BSS) color information provided in beacon reports. As such, the AP may either enable or disable SR for communication based on determination whether the neighboring AP is part of the same enterprise.

### CROSS-REFERENCE TO RELATED APPLICATION(S)

This application claims benefit of U.S. Provisional Application Ser. No. 62/525,055, entitled “EXTENSION OF BEACON REQUEST/REPORT MECHANISM FOR SPATIAL REUSE” and filed Jun. 26, 2017, which is expressly incorporated by reference herein in its entirety.

### BACKGROUND

Aspects of this disclosure relate generally to telecommunications, and more particularly to techniques for extension of the beacon request/report mechanism in IEEE 802.11k for spatial reuse.

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs. In some scenarios, communications that occur in nearby BSSs can result in collisions and failure in the transmission of information.

Spatial reuse techniques may be available to transmit, in certain conditions, over the frames or packets transmitted by another AP. These techniques, however, may require additional information to make the appropriate determination of when to use spatial reuse techniques. Accordingly, it may be desirable to have a mechanism for obtaining information to make better determinations regarding spatial reuse.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In order to facilitate spatial reuse, an access point (e.g., a high efficiency access point or HE AP) may need to know more about other APs in its neighborhood. For example, the AP may need to know if other APs in its neighborhood have enabled spatial reuse (SR). An HE AP can use beacon request/report mechanism (e.g., from IEEE 802.11k) to gather such information. In addition to several default parameters (e.g., default information that may be obtained using a beacon request), the beacon request/report mechanism allows an AP to specify parameters of interest as part of the beacon request to an associated STA via the optional subelement field (e.g., ID 10 for request element and ID 11 for extended request element). Additionally, the AP may need to know whether or not other APs in the neighborhood are part of the same enterprise deployment (e.g., university WLAN on campus using multiple APs deployed across the campus) as the AP. Such determination may be important because in the event that the neighboring APs are part of the same enterprise—or part of the same spatial reuse group (SRG)—the AP and associating STAs may refrain from communicating using SR in order to minimize interference for the neighboring APs. In contrast, if the neighboring AP is not part of the same enterprise, the AP may enable SR for communication in order to maximize resource management.

In some examples, the AP may store a list of unique identifiers (e.g., MAC addresses) associated with one or more APs that may be, for instance, part of the enterprise deployment. Such APs may be classified as “friendly” or “peer” APs. For purposes of the present disclosure, the term “friendly APs” or “peer APs” may refer to APs that may be part of the same enterprise or SRG. Although an AP may have a preconfigured list of unique identifiers of peer APs, the AP, however, may be unaware of the BSS color of each of the neighboring APs because an AP generally selects its respective BSS colors dynamically during operation and the selection of the BSS color (unlike MAC address) is not static. As such, BSS color associated with the neighboring APs may periodically change.

Features of the present disclosure leverage the beacon reports received from one or more STAs at the AP to identify the BSS color information of the one or more neighboring APs in order to identify neighboring APs that may be part of the SRG such that the AP may determine whether to enable or disable SR for communication for the AP and associated STAs. To this end, an HE AP can request a beacon report from one or more non-AP STA to report information regarding observed neighborhood scans. In some examples, the beacon reports may include information related to one or more neighborhood APs whose signal may be detected by the STA. As such, the beacon report may include BSS color information and detected power related to the one or more neighborhood APs and reported to the requesting AP. Based on the BSS color information of the neighboring APs that may be derived from the beacon reports received at the AP from one or more associated STAs, the AP may determine whether any of the BSS colors are associated with the list of unique identifiers neighboring APs (e.g., friendly AP MAC addresses). If the neighboring AP BSS color is associated with a friendly AP MAC address stored in the memory of the AP, the AP may populate a spatial reuse group (SRG) table with a list of friendly BSS colors and advertise the list in the spatial reuse parameter set element to the one or more associated STAs such that the STAs may determine whether or not to use SR operation for communication. Similarly, based on the SRG table, the AP may determine whether to enable or disable SR operations for AP transmissions. Also the SR parameter set can be used by the AP to determine the SR parameters of the neighboring APs.

The beacon report provided by the non-AP STA (or more than one non-AP STA) can also be used by the requesting AP to obtain information about the OBSS AP's location with respect to the reporting STA. This information can be used by the AP to determine if it can transmit a frame to this particular non-AP STA when the OBSS AP is transmitting (e.g., SR over OBSS AP). Further if the AP determines that the neighboring APs are not using SR, the AP may determine to turn off SR (if not currently off). Similarly, if the if the AP determines that the neighboring APs are using SR, the AP may determine to turn on SR (if not currently on).

To this end, in one example, a method for spatial resuse in wireless communications is disclosed. The method may include transmitting, by an AP, a beacon request to one or more associated wireless STAs. The beacon request may include a request for information of neighboring APs. The method may further include receiving, from the one or more STAs, a beacon report regarding at least one of the neighboring APs, wherein the beacon report includes at least a BSS color information of the at least one of the neighboring APs. The method may also include correlating the BSS color information included in the beacon report with one or more unique identifiers associated with a set of peer APs. The method may further include determining whether the at least one of the neighboring APs is a peer AP of the AP based at least in part on correlating the BSS color information with the one or more unique identifier. The method may further include performing one or more operations associated with spatial reuse based on determining whether the at least one of the neighboring APs is the peer AP.

In another example, an AP for wireless communications is disclosed. The AP may include a transceiver and a memory. The AP may also include a processor communicatively coupled to the transceiver and the memory. The processor may be configured to transmit, by the transceiver, a beacon request to one or more associated wireless STAs. The beacon request may include a request for information of neighboring APs. The processor may further be configured to receive, from the one or more STAs, a beacon report regarding at least one of the neighboring APs, wherein the beacon report includes a BSS color information of the at least one of the neighboring APs. The processor may further be configured to correlate the BSS color information included in the beacon report with one or more unique identifiers associated with a set of peer APs. The processor may further be configured to determine whether the at least one of the neighboring APs is a peer AP of the AP based at least on correlating the BSS color information with the one or more unique identifiers. The processor may further be configured to perform one or more operations associated with spatial reuse based on determining whether the at least one of the neighboring APs is the peer AP.

In another example, a computer readable medium storing code for wireless communciations is disclosed. The computer readable medium may comprise code for transmitting, by an AP, a beacon request to one or more associated wireless STAs. The beacon request may include a request for information of neighboring APs. The computer readable medium may further comprise code for receiving, from the one or more STAs, a beacon report regarding at least one of the neighboring APs, wherein the beacon report includes a BSS color information of the at least one of the neighboring APs. The computer readable medium may further comprise code for correlating the BSS color information included in the beacon report with one or more unique identifiers associated with a set of peer APs. The computer readable medium may further comprise code for determining whether the at least one of the neighboring APs is a peer AP of the AP based in part of correlating the BSS color information with the one or more unique identifiers. The computer readable medium may further comprise code for performing one or more operations associated with spatial reuse based on determining whether the at least one of the neighboring APs is the peer AP.

An apparatus for wireless communications is disclosed. The apparatus may include means for transmitting, by an AP, a beacon request to one or more associated wireless STAs. The beacon request may include a request for information of neighboring APs. The apparatus may further include means for receiving, from the one or more STAs, a beacon report regarding at least one of the neighboring APs, wherein the beacon report includes a BSS color information of the at least one of the neighboring APs. The apparatus may further include means for correlating the BSS color information included in the beacon report with one or more unique identifiers associated with a set of peer APs. The apparatus may further include means for determining whether the at least one of the neighboring APs is a peer AP of the AP based on correlating the BSS color information with the one or more unique identifiers. The apparatus may further include means for performing one or more operations associated with spatial reuse based on determining whether the at least one of the neighboring APs is the peer AP.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a schematic diagram illustrating an example of a wireless local area network (WLAN) deployment.

FIG. 2 is a diagram illustrating aspects of a beacon request/report mechanism.

FIG. 3 is a diagram illustrating aspects of a request and an extended request subelements.

FIG. 4 is a diagram illustrating an example scenario, in accordance with various aspects of the present disclosure.

FIG. 5 is a schematic diagram of a communication network including aspects of an AP configured for using IEEE 802.11k extension for spatial reuse, in accordance with various aspects of the present disclosure.

FIG. 6 is a schematic diagram of a communication network including aspects of an STA configured for using IEEE 802.11k extension for spatial reuse, in accordance with various aspects of the present disclosure.

FIG. 7 is a flow diagram illustrating an example of a method, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

Spatial reuse or SR, a feature introduced by Task Group AX or TGax (e.g., associated with IEEE 802.11ax), allows an STA or an AP to transmit on top of an OBSS frame under certain conditions (e.g., is SR enabled on the device, is SR permitted as indicated by the received frame, is the received frame below certain threshold (ED/PD)). TGax also allows neighboring APs to form a spatial reuse group, which can be useful in a managed network. This disclosure described the extension of the beacon request/report mechanism in IEEE 802.11k to gather information about the neighborhood (such as BSS color, SR), which can be used by the requesting AP make decisions pertaining to SR.

As described above, in order to facilitate spatial reuse, an access point (e.g., a high efficiency access point or HE AP) may need to know more about other APs in its neighborhood. For example, the AP may need to know if other APs in its neighborhood have enabled spatial reuse (SR). Additionally, the AP may need to know whether or not other APs in the neighborhood are part of the same enterprise deployment (e.g., university WLAN on campus using multiple APs deployed across the campus) as the AP. Such determination may be important because in the event that the neighboring APs are part of the same enterprise—or part of the same spatial reuse group (SRG)—the AP may refraim from communicating using SR in order to minimize interference for the neighboring APs. In contrast, if the neighboring AP is not part of the same enterprise or not a peer AP, the AP may enable SR for communication in order to maximize resource management.

In order to facilitate determining whether one or more neighboring APs are part of the SRG, an HE AP can use beacon request/report mechanism (e.g., from IEEE 802.11k) to gather such information. For example, in addition to several default parameters (e.g., default information that may be obtained using a beacon request), the beacon request/report mechanism allows an AP to specify parameters of interest as part of the beacon request to an associated STA via the optional subelement field (e.g., ID 10 for request element and ID 11 for extended request element).

For SR, an HE AP can request a non-AP STA to also report the HE operations element and spatial reuse (SR) parameter set element of the neighboring APs. The HE operations elements can be used by the AP to determine the neighboring BSS color information for the neighboring APs. Features of the present disclosure leverage the beacon reports received from one or more STAs at the AP to identify the BSS color information of the one or more neighboring APs in order to identify neighboring APs that may be part of the SRG such that the AP may determine whether to enable or disable SR for communication for the AP and associated STAs. To this end, an HE AP can request a beacon report from one or more non-AP STAs to report information regarding observed neighborhood scans. In some examples, the beacon reports may include information related to one or more neighborhood APs whose signal may be detected by the STA. As such, the beacon report may include BSS color information and detected power related to the one or more neighborhood APs and reported to the requesting AP. Based on the BSS color information of the neighboring APs that may be derived from the beacon reports received at the AP from one or more associated STAs, the AP may determine whether any of the BSS colors are associated with the list of unique identifiers neighboring APs (e.g., friendly/peer AP MAC addresses).

Specifically, in some examples, the AP may store a list of unique identifiers (e.g., MAC addresses) associated with one or more APs that may be, for instance, part of the enterprise deployment. As noted above, such APs may be classified as “friendly” or “peer” APs. For purposes of the present disclosure, the term “friendly APs” or “peer APs” may refer to APs that may be part of the same enterprise or SRG.

If the neighboring AP BSS color is associated with a friendly or peer AP MAC address stored in the memory of the AP, the AP may populate a spatial reuse group (SRG) table with a list of friendly BSS colors and advertise the list in the spatial reuse parameter set element to the one or more associated STAs such that the STAs may determine whether or not to use SR operation for communication. Similarly, based on the SRG table, the AP may determine whether to enable or disable SR operations for AP transmissions. Also the SR parameter set can be used by the AP to determine the SR parameters of the neighboring APs.

The beacon report provided by the non-AP STA (or more than one non-AP STA) can also be used by the requesting AP to obtain information about the OBSS AP's location with respect to the reporting STA. This information can be used by the AP to determine if it can transmit a frame to this particular non-AP STA when the OBSS AP is transmitting (e.g., SR over OBSS AP). Further if the AP determines that the neighboring APs are not using SR, the AP may determine to turn off SR (if not currently off). Similarly, if the if the AP determines that the neighboring APs are using SR, the AP may determine to turn on SR (if not currently on).

Aspects of techniques for extending IEEE 802.11k for spatial reuse are provided in more detail in the following description and related drawings directed to specific disclosed aspects. The present methods and apparatuses may provide an efficient solution, as compared to current proposals, as described above. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

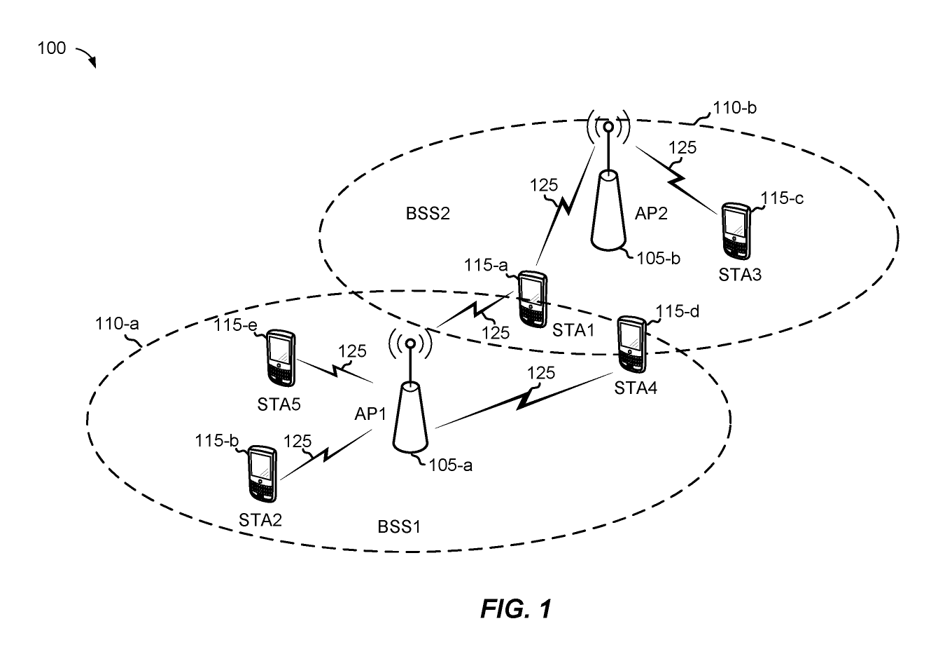

FIG. 1 is a wireless communication system 100 illustrating an example of a wireless local area network (WLAN) deployment in connection with various techniques described herein. The WLAN deployment may include one or more access points (APs) and one or more wireless stations (STAs) associated with a respective AP. In this example, there are only two APs deployed for illustrative purposes: AP1 105-a in basic service set 1 (BSS1) and AP2 105-b in BSS2. AP1 105-a is shown having at least two associated STAs (STA1 115-a, STA2 115-b, STA4 115-d, and STA5 115-e) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b, STA3 115-c, STA4 115-d, and STA5115-e) shown in FIG. 1, which may be fixed, non-fixed, or mobile terminals, utilize the backhaul services of their respective AP to connect to a network (see e.g., network 818 in FIGS. 8 and 9), such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed.

In an aspect, an AP 105 may perform various operations that use the extension of the beacon request/report mechanism of IEEE 802.11k to obtain information for making spatial reuse determinations.

In another aspect, an STA 115 may receive a beacon request and may provide the requested information from any neighboring APs that is available to the STA 115.

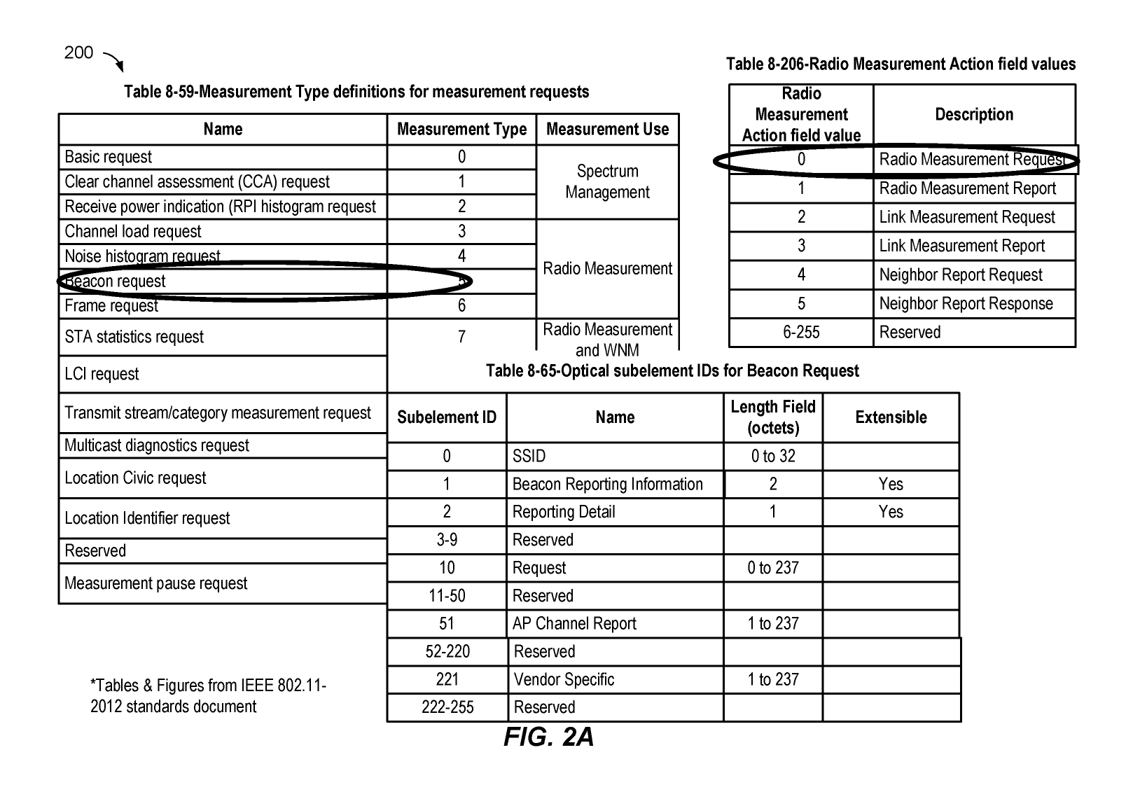

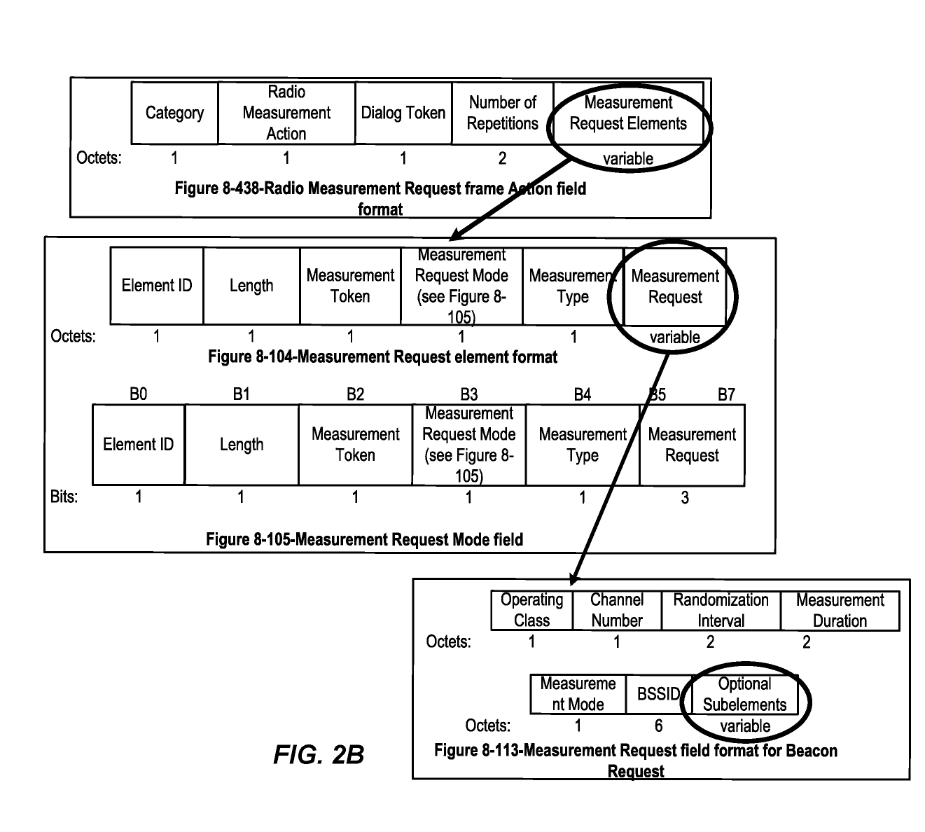

Additional details as to the operation of an AP1 105 or an STA 115 in connection with the present disclosure are provided below in connection with FIGS. 2-7. As described below, the term transmission may refer to a transmission received by a device or may refer to a transmission by a device, according to context.

As described above, IEEE 802.11ax allows for spatial reuse (SR). Spatial reuse allows an STA or AP to transmit on top or over an OBSS transmission, that is, a transmission from a different BSS. If the STA receives a transmission from another BSS, and certain conditions are met (e.g., the other AP indicates that spatial reuse can be used over the other AP's transmissions), then the STA can apply spatial reuse and transmit over the frame or packet from the other BSS.

In some aspects, the other AP may provide an indication in a bit, for example, that when such a bit is set spatial reuse is allowed and when such a bit is not set spatial reuse is not allowed. Other conditions to consider when applying spatial reuse can be the power level (e.g., signal strength or RSSI) of the other AP or energy detected of the other AP as seen by the STA.

IEEE 802.11ax also allows the use of spatial reuse groups or SRGs. For example, if a set of APs are deployed by a particular provider or operator in a particular location (e.g., a mall), and if all of them belong to the same SRG, then the AP using the extended beacon request/report mechanism may know the color (e.g., BSS color) of each of the members in the group. The BSS color is a value between 0 and 63, with 0 and 63 reserved, so the range is essential 1-62. Each AP can pick one of these values (e.g., randomly or pseudorandomly) and identify it as its unique color or BSS color. When an STA receives a transmission, the STA can read the PHY header and the STA can quickly determine if the transmission is from the STA's BSS or from outside the STA's BSS based on the BSS color in the PHY header.

An STA that receives a transmission (e.g., packet or frame), and determines that the BSS color of the transmission does not match the BSS color of the STA's AP or BSS, then the STA can simply ignore the transmission, go to sleep, or do something else for the remaining duration of the transmission. In the PHY header the STA can read the BSS color, the SR parameter value, and TxOP, which is the time the transmission (e.g., packet or frame) is expected to last.

When the BSS color in the PHY header does not match the BSS color of the STA's AP or BSS, the STA can go to sleep. From the SR parameter value the STA can determine if it is allowed to use SR, and if certain conditions are met and if the STA has information to transmit in its buffer, then the STA may determine to transmit over the packet or frame being received.

Accordingly, BSS color and SR can be used by the STA, or by an AP, to determine whether to reuse (e.g., apply spatial reuse) on top of a packet or frame being received.

In an SRG, each AP can have a unique BSS color, and a spatial reuse parameter element can have a bitmap where each bit indicates whether a particular color belongs to the SRG or not. For example, a BSS color in a received transmission may not match the BSS color of a device but it is one of the BSS colors in the SRG and spatial reuse is permitted in the SRG. In such a scenario, the device can reuse on top of the packet or frame being received. When spatial reuse is not permitted in the group, the device would not reuse on top of the packet or frame.

Other parameters for consideration include the OBSS packet detection (PD) value (or SRG OBSS PD value). Within an SRG, when the device (e.g., STA or AP) determines the transmission (e.g., packet or frame) belongs to its group, and the OBSS PD value is within a threshold, the device may reuse on top of the transmission. When the threshold is not met, then the device may not reuse because it may cause interference.

For non-SRG, meaning that the packet or frame being received does not belong to the device's group, but the transmission occur within a certain range, then spatial reuse may be determined based on whether the SR bit value is set or not.

Another aspect of consideration in addition to BSS color is that the SR parameter also provided information about a partial BSS ID. That is, the SR parameter may not provide a full BSS ID because each BSS ID will require 6 octets. Instead, the SR parameter may represent multiple APs by carrying a partial BSS ID field. For example the partial BSSID field could use 8 octets to represent up to 2⁶ BSS IDs.

Accordingly, a device can use the BSS color or BSS ID, the SR bit, and the SRG OBSS PD value to determine whether it can reuse over a packet or frame. Thus, the device may use information such as various combinations of the SS ID, BSS ID, RSSI of the received frame, the partial BSS ID, or the BSS color. Additionally, the AP may use the BSS color information associated with the neighboring APs from the beacon reports to determine whether to enable or disable SR. Specifically, the AP may populate the SRG table with a list of friendly BSS colors by correlating the BSS color information of the one or more neighboring APs received in the beacon reports with the preconfigured list of friendly MAC addresses. Accordingly, the AP may advertise the list of friendly BSS colors in a spatial reuse parameter set element to the one or more associated STAs such that the STAs may determine the BSS colors over which SR operation may be enabled.

Specifically, an AP may request a beacon report from one or more non-AP STAs to report information regarding other APs in the neighborhood based on observed signals (e.g., signals received by the STA). The AP can also request a non-AP STA to also report the HE operations element and SR parameter set element of the neighboring APs. The HE operations elements can be used by the AP to determine the neighboring BSS color information for the neighboring APs.

Thus, in some examples, the beacon reports may include information related to one or more neighborhood APs whose signal may be detected by the STA. The beacon report may include BSS color information and detected power related to the one or more neighborhood APs and reported to the requesting AP. Based on the BSS color information of the neighboring APs that may be derived from the beacon reports received at the AP from one or more associated STAs, the AP may determine whether any of the BSS colors are associated with the list of unique identifiers neighboring APs (e.g., friendly AP MAC addresses). If the neighboring AP BSS color is associated with a friendly AP MAC address stored in the memory of the AP, the AP may populate a SRG table with a list of friendly BSS colors and advertise the list in the spatial reuse parameter set element to the one or more associated STAs such that the STAs may determine whether or not to use SR operation for communication. Similarly, based on the SRG table, the AP may determine whether to enable or disable SR operations for AP transmissions.

Additionally, in some cases, the AP may be able to determine (based on the reported signal strength for a particular neighboring AP) whether the AP can perform SR operation to transmit a frame to one of its client devices (e.g., STAs). For example, STA_1 in its beacon report has reported that AP2 in the neighborhood is using color 24 and STA_1 senses the AP2 at −75 dBm. The STA_1 may provide the information regarding the neighbor AP2, including the AP2 BSS color information (e.g., color 24) and the detected power signal (e.g., −75 dBm) to the requesting AP (e.g., AP_1). Based on the beacon report, the requesting AP (e.g., AP_1), with whom STA_1 is associated with (and has provided a beacon report), may determine that AP_2 is not a friendly AP and that AP_1 can perform SR when AP_1 senses a frame with color 24. As such, in such instance, AP_1 can enable SR to transmit a frame to STA_1 when AP_1 senses that AP_2 is transmitting a frame because STA_1 will likely hear AP_2 transmissions that are at a signal strength lower than the threshold (say −72 dB) for performing SR.

In contrast, if the requesting AP (e.g., AP_1) determines that the second AP (e.g., AP_2) is a friendly AP based on correlation with the list of friendly AP MAC addresses stored at the requesting AP, the requesting AP may disable SR for transmissions of frames during periods that the AP_2 is transmitting.

Thus, in general, features of the present disclosure allow an AP to acquire information about its neighboring APs to determine whether it can reuse spatial frequency on top of a received packet or frame. A deployed AP, however, may not have information about its neighboring APs. A brute force method could have an operator pre-populate some of this information, but that would be cumbersome and may not be useful when information dynamically changes. Another mechanisms is to have the AP obtain this information. As long as the AP is provided with a list of the APs in its SRG (e.g., the APs with the same BSS IDs or in the BSS color bitmap), then the AP can obtain information about APs in its neighborhood. Such information regarding the neighborhood may allow the AP to either enable or disable SR for communication.

In order to learn or obtain information about its neighborhood, an AP can use a beacon request/report mechanism outlined in IEEE 802.11k. In some systems, only a device that is capable of or intends to perform spatial reuse would be required to support the beacon request/report mechanism described herein. FIG. 2 shows a diagram 200 illustrating aspects of a beacon request/report mechanism, including various tables that describe fields and elements associated with the beacon report/request mechanism. The beacon report/request mechanism is part of a radio management mechanism that is extensive and elaborate, and has many variances. Under this scheme, an AP can request from its associated STAs (e.g., non-AP STAs or client devices) to obtain certain information about the neighborhood. As illustrated in diagram 200, the AP may request beacon reports based on radio measurement request (see Table 8-205—Radio Measurement Action field values) where Radio measurement action field value of “0” for example may be associated with a radio measurement request. The measurement type definitions for measurement requests may be defined from table 8-59 (e.g., Beacon request in measurement type “5”).

Thus, the radio measurement request frame (as shown in 8-438—Radio Measurement Request frame Action field format) may include a measurement request elements that may vary in size and include measurement request mode, the measurement type (derived from measurement type definitions of table 8-59 that identifies beacon request) and include an element for measurement request. In some examples, the measurement request may further include optional subelements that the AP may request one or more STAs to provide to the AP in the beacon report, including the signal power detected levels of the neighboring APs and BSS color information of the one or more neighboring APs. The optional subelement requests may be selected from Table 8-65 in diagram 200 titled “Optional subelement IDs for Beacon Request.”

The AP can be flexible enough to present different types of requests. For example, the AP can request from an STA to scan all available channels, to only scan a subset of the channels, or a single channel. For example, in some systems, the AP may request gathering information from only those channels on which it intends to perform spatial reuse. In addition, the AP may request from an STA to provide any and all information it can gather, or to provide information pertaining only to certain BSS IDs or certain SS IDs.

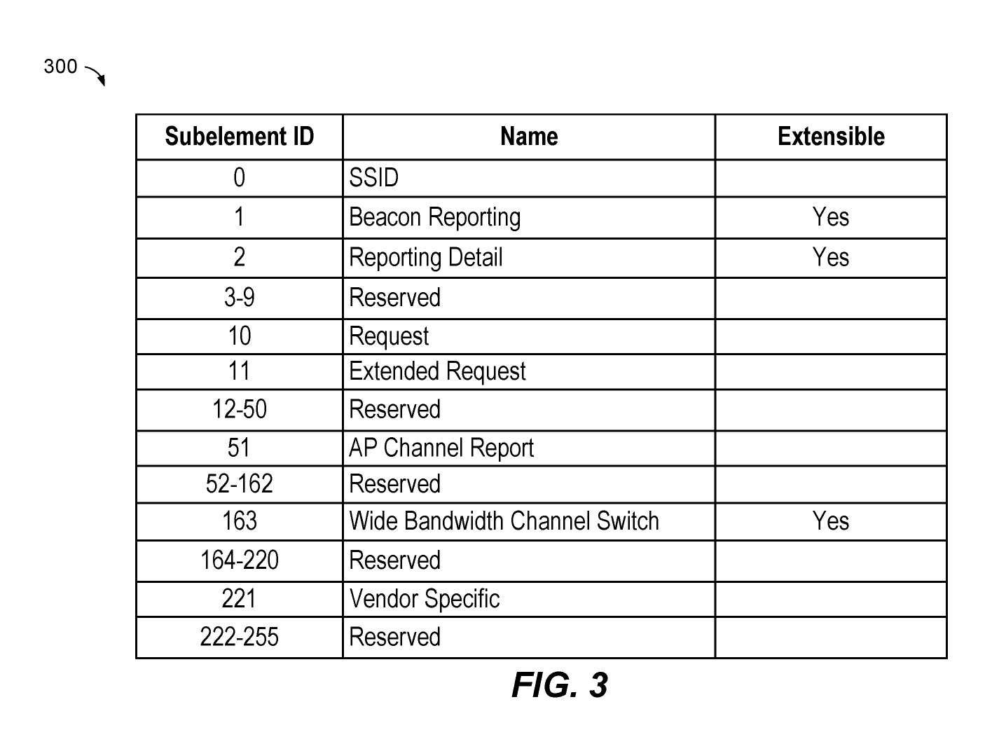

There are optional subelement fields that can be carried in the beacon request. For purposes of this disclosure, two of those optional subelement fields that can be used for spatial reuse applications are the request element field and the extended element field. FIG. 3 shows a diagram 300 illustrating aspects of a request and an extended request subelements, including a table describing features associated with these subelements.

The request element or subelement is placed in a Probe Request frame or Information Request frame to request that the responding STA include the requested information in the Probe Response frame or Information Response frame, respectively. The format of the element is as shown below in FIG. 9-135 (Request element).

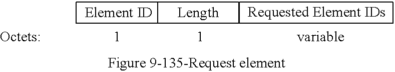

The Element ID and Length fields are defined in IEEE 802.11ax, section 9.4.2.1 (General). The Requested Element IDs are the list of elements that are requested to be included in the Probe Response or Information Response frame. The Requested Element IDs are listed in order of increasing element ID. The Requested Element IDs within a Request element transmitted in an Information Request frame do not include an element ID that corresponds to an element that will be included in the Information Response frame even in the absence of the Request element, as shown in Table 9-407 (Information Response frame Action field format) of IEEE 802.11ax. A given element ID is included at most once among the Requested Element IDs.

The extended request element or subelement is placed in a Probe Request frame or Information Request frame to request that the responding STA include the requested information in the Probe Response frame or Information Response frame, respectively. The format of the element is as shown below in FIG. 9-136 (Extended Request element).

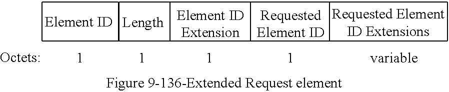

The Element ID, Element ID Extension, and Length fields are defined in IEEE 802.11ax, section 9.4.2.1 (General). The Requested Element ID field contains one of the Element IDs used to indicate an extended element. The Requested Element ID Extensions field contains a list of 1-octet element ID extension values that, combined with the value of the Requested Element ID field, identify elements that are requested to be included in the Probe Response or Information Response frame. The values in this field are listed in increasing order. The requested elements within an Extended Request element transmitted in a Probe Request frame do not identify an element that will be included in the Probe Response frame even in the absence of the Request element, or will be excluded from the Probe Response frame even in the presence of the Extended Request element as described by the notes in Table 9-34 (Probe Response frame body). The requested elements within an Extended Request element transmitted in an Information Request frame do not identify an element that will be included in the Information Response frame even in the absence of the Extended Request element, as shown in Table 9-407 (Information Response frame Action field format). A given element ID extension value is included at most once in the Requested Element ID Extensions field.

As described above, the request element carries a list of element IDs, where each element has its own ID, and where each ID is represented by an 8-bit field (1 octet, 8 bits to represent 256 different values—with certain values reserved). For example, there could be 240 values or elements that could be represented. One element could be SS ID, another could be BSS color, and another could be SR, for example. The requesting AP can then request for this information from its associated STAs for specific APs (e.g., neighbors).

The STA, when preparing or packing the beacon report (e.g., the response to the beacon request), can include any information that was collected or gathered for these additional fields that the AP requested. Some neighboring APs may not support these features and may not advertise the information requested by the AP.

In this disclosure, an AP can use the beacon request/report mechanism to gather information about the neighborhood (e.g., neighboring APs), and the AP can use the request element and the extended request element to ask or request additional information.

Extended request element is applied in part because almost all elements in IEEE 802.11ax are extended elements. For example, for IEEE 802.11ax, the high efficiency (HE) operations element ID field can be identified by using 255 for the element ID and another value for the extended element ID. Same for HE capabilities, which can be identified by using 255 for the element ID and a value different from the one used for HE operations for the extended element ID. That is, using this approach, it is possible to extend the range of the element ID by using the extended element ID field to carry more information.

An AP can therefore use the beacon request/report mechanism and optional subelement fields (e.g., request and extended request) to request additional information of the neighboring APs, where that information or capabilities can include, but need not be limited to, BSS color information, BDD ID information, and/or SR parameter information.

Aspects of the present disclosure include how to gather this information and how to use the information that is gathered. For example, one aspect of the disclosure includes the use of the beacon request/report mechanism to request specific information about neighboring APs. This request is typically beyond a standard or default request, and asks for additional information from that which is typically provided. The beacon request can ask or request for HE operations element because it carries information about the BSS color and it is useful to the AP to know the BSS color of the neighboring APs to make determinations regarding spatial reuse. Another type of information that may be requested is the SR parameter, because it can give additional information about the SRG, which APs are part of the SRG and which are not, whether the requesting AP can reuse or not, and what are the OBSS PD values.

Once the information is collected and provided to the requesting AP (e.g., by beacon reports from the associated STAs), the AP can perform various operations. For example, when the AP is part of a particular SRG, if the neighboring APs are not using spatial reuse, then the AP may determine not to use spatial reuse. If the neighboring APs are using spatial reuse, then the AP may determine to use spatial reuse.

On the other hand, if the requesting AP is not part of an SRG, the AP can still look at the behavior of its neighboring APs. The AP can then use spatial reuse when its neighboring APs use spatial reuse, and not use spatial reuse when its neighboring APs do not use spatial reuse.

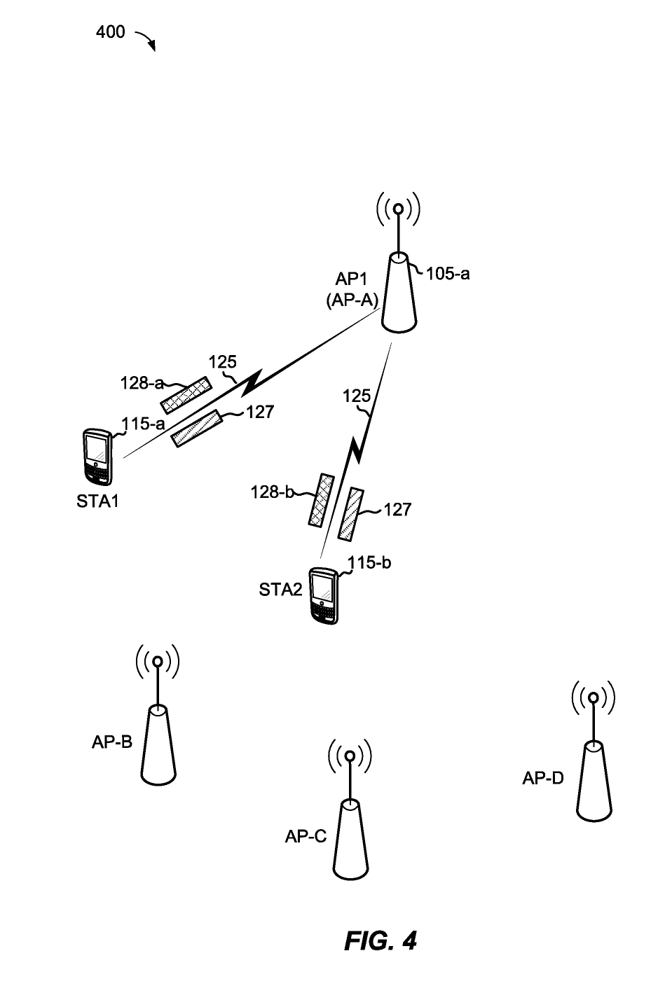

The requesting AP may also perform operation based at least in part on the signal strength of neighboring APs. A non-AP STA can provide, as part of the beacon report, information about how far the neighboring APs are based on signal strength (e.g., received signal strength indicator or RSSI) at the STA. FIG. 4 shows a diagram 400 illustrating an example scenario. As shown in FIG. 4, an AP-A (e.g., AP-1 105-a) can request from an STA-1 (e.g., STA-1 115-a) to gather information about neighboring APs. The request can be a beacon request 127. The STA-1 can report back (e.g., via beacon report 128-a) and indicate the presence of three neighboring APs, AP-B, AP-C, and AP-D. In the report, STA-1 can also indicate that AP-B has a strong signal, AP-C has a signal with medium strength, and AP-D has a signal with weak strength. When AP-A want so transmit to STA-1, AP-A can make a determination of what is the OBSS PD that AP-B will see when AP-A transmits to STA-1. This determination may be used by AP-A to make spatial reuse determinations regarding AP-B.

With the reporting (e.g., beacon reports) of the signal strength (e.g., RSSI) of neighboring APs, the AP-A can make determinations as to how when to use spatial reuse. For example, since transmissions to STA-1 from AP-B are strong, even if SR is turned on (e.g., enabled) for AP-A, AP-A may determine not to transmit to STA-1 because it is clear that such transmission will interfere with the transmission from AP-B.

On the other hand, if STA-2 (e.g., STA-2 115-b) reports (e.g., beacon report 128-b) that AP-B shows a low RSSI, then AP-A may determine that it can use spatial reuse when AP-B is transmitting to STA-2. Moreover, because multiple-input-multiple-output (MIMO) and beamforming techniques can be supported by AP-A, it is likely that the transmission of AP-A to STA-2 will not interfere with the transmission from AP-B.

Therefore, the AP (e.g., AP-A) can determine which clients to transmit and reuse based at least in part on which neighboring APs are transmitting at that point.

Another aspect that can be addressed based on the information provided by the beacon reporting is having the requesting AP determine whether there are any color collisions (e.g., BSS color collisions). In one scenario, there may be another AP in the neighborhood that is using (e.g., has picked or selected) the same BSS color as that of the requesting AP. One or more beacon reports from client devices may indicate that there is another AP in the neighborhood that is using the same color ID (e.g., BSS color ID) as the requesting AP. For these client devices, it is ambiguous when they obtain the color ID from the PHY header because they don't know if the frame or packet is coming from the requesting AP or from the other AP.

BSS color collisions can be determined when, for example, as part of the beacon report, information is provided about HE operations element, from which the AP can determine the BSS color and further determine whether there is a BSS color collision.

Another aspect related to the information provided by the beacon report and useful to the AP for purposes of spatial reuse is the ability of the AP to determine the partial BSS ID from the SR parameter set. The SR parameter set can be used by the AP to determine which of the neighboring APs belongs to the same SRG as the AP. That is, based on the SR parameter set, it is possible to determine if the neighboring APs belong to the same group as the AP or belong to a different group that the SRG of the AP.

Therefore, from SS ID, SR parameter set, and/or HE operations element (e.g., BSS color ID) information gathered or collected by the requesting AP, that AP can determine which neighboring APs are in the same SRG, whether or not those APs are reusing (e.g., applying spatial reuse), to turn on or off spatial reuse, and if reuse is turned on, then based on the signal strength (e.g., RSSI) information, determine under which conditions can the AP reuse over a particular neighboring AP. In addition, the AP can further determine if there is a BSS color collision from this information.

All these parameters are typically included in the PHY header such that the AP, without having to process the rest of the frame or packet, can make a quick determination of whether to reuse on top of the frame or packet.

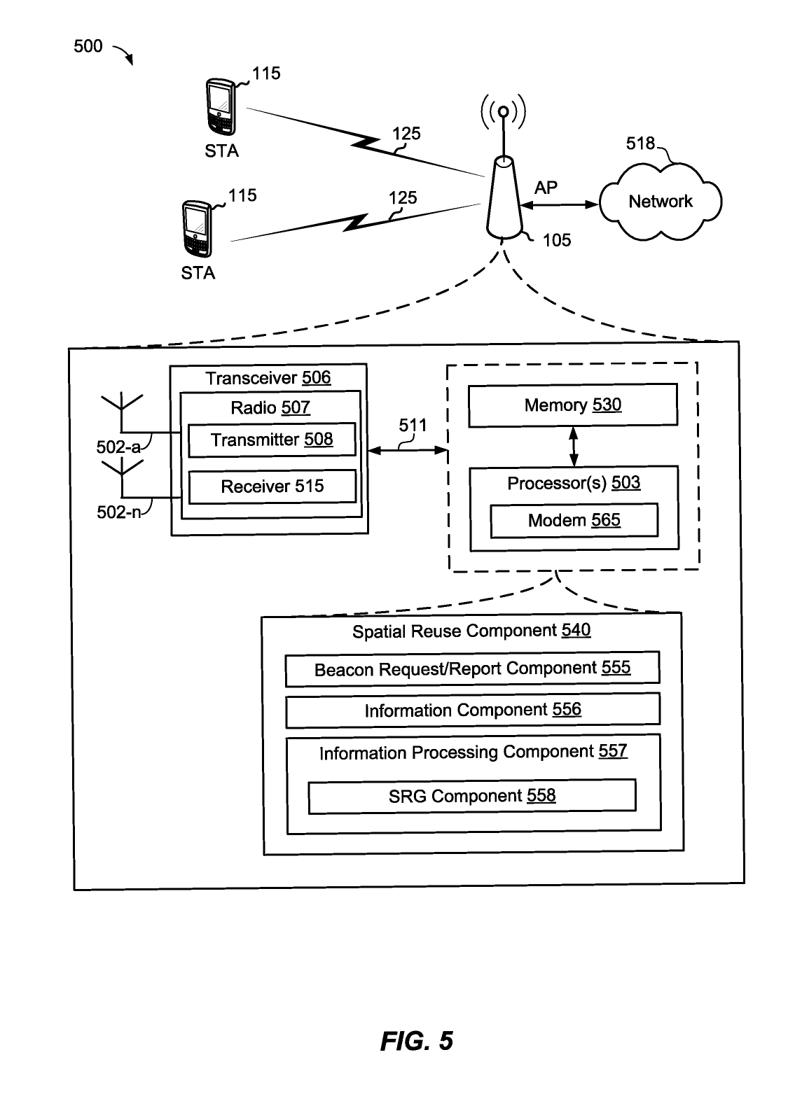

Referring to FIG. 5, in an aspect, a wireless communication system 500 includes multiple STAs 115 in wireless communication with at least one AP 105 connected to network 518. The STAs 115 may communicate with network 518 via AP 105. In an example, STAs 115 may transmit and/or receive wireless communication to and/or from AP 105 via one or more communication links 125. Such wireless communications may include, but are not limited to, data, audio and/or video information. In some instances, such wireless communications may include control or similar information. In an aspect, an AP, such as AP 105 may be configured to perform techniques described herein for extending IEEE 802.11k for spatial reuse.

In accordance with the present disclosure, AP 105 may include a memory 530, one or more processors 503 and a transceiver 506. The memory 530, the one or more processors 503 and the transceiver 506 may communicate internally via a bus 511. In some examples, the memory 530 and the one or more processors 503 may be part of the same hardware component (e.g., may be part of a same board, module, or integrated circuit). Alternatively, the memory 530 and the one or more processors 503 may be separate components that may act in conjunction with one another. In some aspects, the bus 511 may be a communication system that transfers data between multiple components and subcomponents of the AP 105. In some examples, the one or more processors 503 may include any one or combination of modem processor, baseband processor, digital signal processor, and/or transmit processor. Additionally or alternatively, the one or more processors 503 may include a modem 565 having an energy detection component 540 for carrying out one or more methods or procedures described herein. The spatial reuse component 540 may comprise hardware, firmware, and/or software and may be configured to execute code or perform instructions stored in a memory (e.g., a computer-readable storage medium).

In some examples, the memory 530 may be configured for storing data that is used in connection with local applications, and/or in connection with the spatial reuse component 540 and/or one or more of its subcomponents being executed by the one or more processors 503. Memory 530 can include any type of computer-readable medium usable by a computer or processor 503, such as random access memory (RAM), read only memory (ROM), tapes, magnetic discs, optical discs, volatile memory, non-volatile memory, and any combination thereof. In an aspect, for example, memory 530 may be a computer-readable storage medium (e.g., a non-transitory medium) that stores computer-executable code. The computer-executable code may define one or more operations or functions of the spatial reuse component 540 and/or one or more of its subcomponents, and/or data associated therewith. The computer-executable code may define these one or more operations or functions when AP 105 is operating processor 503 to execute the spatial reuse component 540 and/or one or more of its subcomponents. In some examples, the AP 105 may further include the transceiver 506 for transmitting and/or receiving one or more data and control signals (e.g., messages) to/from an STA. For example the AP 105 may transmit beacon requests and may receive beacon reports. The transceiver 506 may comprise hardware, firmware, and/or software and may be configured to execute code or perform instructions stored in a memory (e.g., a computer-readable storage medium). The transceiver 506 may include one or more radios, including a radio 507 comprising a transmitter 508 and a receiver 515. The radio 507 may utilize one or more antennas 502 (e.g., antennas 502-a, . . . , 502-n) for transmitting signals to and receiving signals from a plurality of STAs. The receiver 515 may include one or more components that form a receiving chain and the transmitter 508 may include one or more components that form a transmitting chain.

The spatial reuse component 540 may include a beacon request/report component 555, configured to perform various aspects described herein regarding the beacon request/report mechanism. The spatial reuse component 540 may also include an information component 556 configured to identify, store, and otherwise handle different types of information requested by the AP 105 and received by the AP 105. The spatial reuse component 540 may also include an information processing component 557 configured to perform one or more of the operations described herein that make use of the information requested/received by the AP 105.

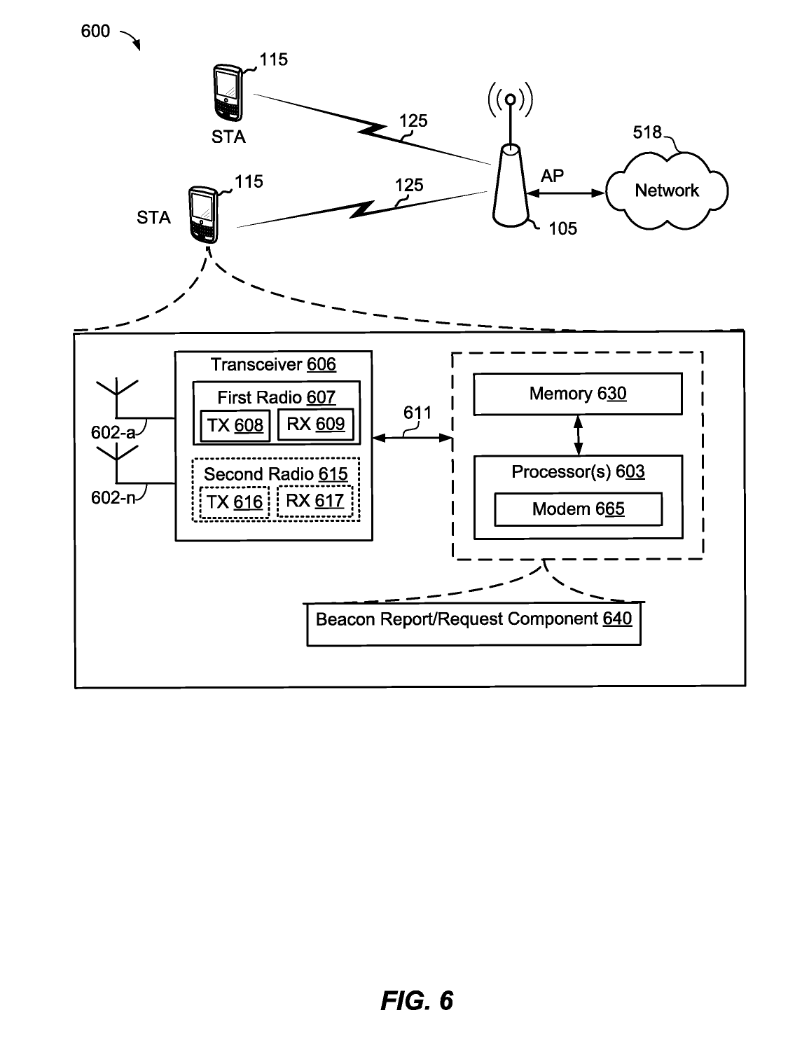

Referring to FIG. 6, in an aspect, a wireless communication system 600 is shown similar to the wireless communication system 500 in FIG. 5. In an aspect, one or more of the STAs 115 may be configured to participate in the beacon request/report mechanism described herein.

In accordance with the present disclosure, an STA 115 may include a memory 630, one or more processors 603 and a transceiver 606. The memory 630, the one or more processors 603 and the transceiver 606 may communicate internally via a bus 611. In some examples, the memory 630 and the one or more processors 603 may be part of the same hardware component (e.g., may be part of a same board, module, or integrated circuit). Alternatively, the memory 630 and the one or more processors 603 may be separate components that may act in conjunction with one another. In some aspects, the bus 611 may be a communication system that transfers data between multiple components and subcomponents of the STA 115. In some examples, the one or more processors 603 may include any one or combination of modem processor, baseband processor, digital signal processor, and/or transmit processor. Additionally or alternatively, the one or more processors 603 may include a modem 665 having an beacon request/report component 640 for carrying out one or more methods or procedures described herein. The beacon request/report component 640 may comprise hardware, firmware, and/or software and may be configured to execute code or perform instructions stored in a memory (e.g., a computer-readable storage medium).

In some examples, the memory 630 may be configured for storing data that is used in connection with local applications, and/or in connection with the beacon request/report component 640 and/or one or more of any subcomponents being executed by the one or more processors 603. Memory 630 can include any type of computer-readable medium usable by a computer or processor 603, such as random access memory (RAM), read only memory (ROM), tapes, magnetic discs, optical discs, volatile memory, non-volatile memory, and any combination thereof. In an aspect, for example, memory 930 may be a computer-readable storage medium (e.g., a non-transitory medium) that stores computer-executable code. The computer-executable code may define one or more operations or functions of the beacon request/report component 640 and/or one or more of any subcomponents, and/or data associated therewith. The computer-executable code may define these one or more operations or functions when STA 115 is operating processor 903 to execute the beacon request/report component 640 and/or one or more of any subcomponents. In some examples, the STA 115 may further include the transceiver 606 for transmitting and/or receiving one or more data and control signals (e.g., messages) to/from an STA. The transceiver 606 may comprise hardware, firmware, and/or software and may be configured to execute code or perform instructions stored in a memory (e.g., a computer-readable storage medium). The transceiver 606 may include multiple radios that enable the STA 115 to operate as a multi-mode device or client. In this example, the transceiver 606 may include a first radio 607 having a transmitter (TX) 608 and a receiver (RX) 609, and a second radio 615 having a TX 616 and a RX 617. The first radio 607 may be a WLAN or Wi-Fi radio and the second radio 615 may be a non-WLAN system or non-Wi-Fi system radio (e.g., an LAA radio, an LTE-U radio).

Each of the first radio 607 and the second radio 615 may utilize one or more antennas 602 (e.g., antennas 602-a, . . . , 602-n) for transmitting signals to and receiving signals from an AP. The receivers 609 and 617 may include one or more components that form a receiving chain, and the transmitters 608 and 616 may include one or more components that form a transmitting chain.

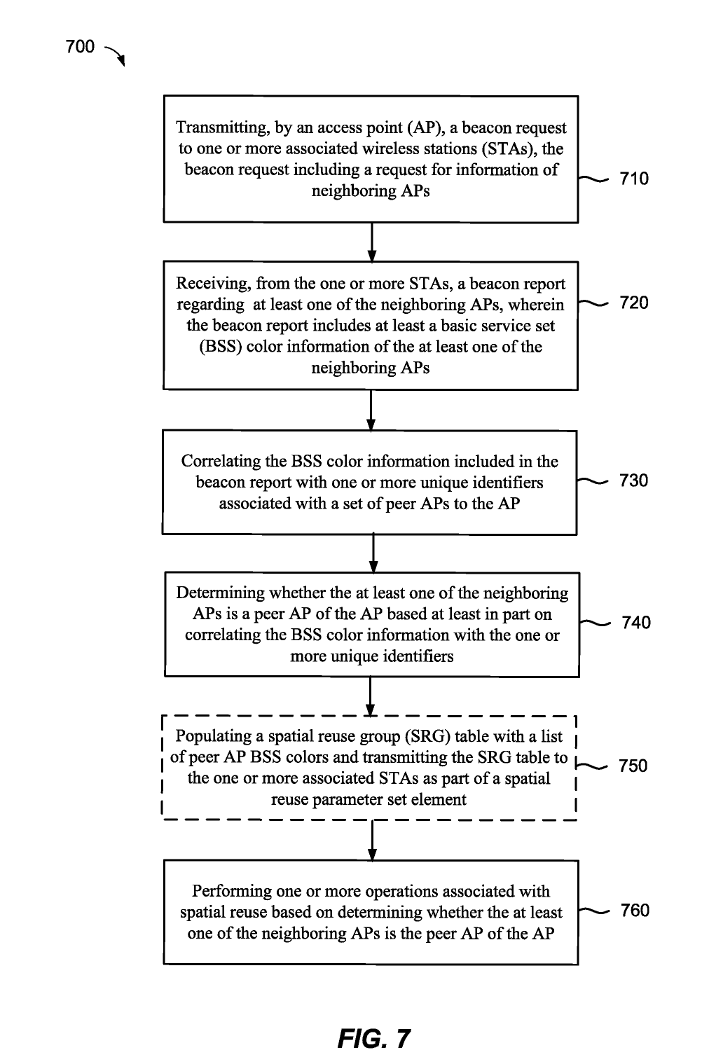

Referring to FIG. 7, examples of one or more operations related to the AP 105 (FIG. 5) according to the present apparatus and methods are described with reference to one or more methods and one or more components. Although the operations described below are presented in a particular order and/or as being performed by an example component, it should be understood that the ordering of the actions and the components performing the actions may be varied, depending on the implementation. Moreover, it should be understood that the following actions may be performed by a specially-programmed processor, a processor executing specially-programmed software or computer-readable media, or by any other combination of a hardware component and/or a software component specially configured for performing the described actions or components.

FIG. 7 is a flow diagram illustrating an example of a method 700, in accordance with various aspects of the present disclosure. In some examples, the method 700 may be performed by an AP 105 described with reference to FIG. 5.

At block 710, the method 700 may include transmitting, by an access point (AP), a beacon request to one or more associated wireless stations (STAs), the beacon request including a request for information of neighboring APs. In one aspect, the transceiver 506, the processor 503, the modem 565, the spatial reuse component 540, the beacon request/report component 555, and/or the information component 556 may be used to transmit the beacon request.

At block 720, the method 700 may include receiving, from the one or more STAs, a beacon report regarding at least one of the neighboring APs. In some examples, the beacon report may include at least a BSS color information of the at least one of the neighboring APs. In some examples, the beacon report may further include information regarding detected power signal(s) of the at least one of the neighboring APs. The beacon report may be reported by the one or more STAs either periodically or based on an event trigger. For example, the event trigger may include the at least one of the neighboring APs dynamically modifying or changing the BSS color information associated with the at least one of the neighboring APs. In such situation, the AP may receive an updated beacon report with updated BSS color information regarding the neighboring APs. In one aspect, the transceiver 506, the processor 503, the modem 565, the spatial reuse component 540, the beacon request/report component 555, and/or the information component 556 may be used to receive the information.

At block 730, the method 700 may include correlating the BSS color information included in the beacon report with one or more unique identifiers associated with a set of peer APs of the AP. In some examples, the one or more unique identifiers of peer APs stored at the AP may be a preconfigured list of MAC addresses of the peer APs. In some examples, the unique identifiers associated with the set of peer APs may fail to include corresponding BSS color information for each of APs in the set of peer APs. Aspects of block 730 may be performed by information processing component 557 described with reference to FIG. 5.

At block 740, the method 700 may include determining whether the at least one of the neighboring APs is a peer AP of the AP based at least in part on correlating the the BSS color information with the one or more unique identifiers. In one aspect, the information processing component 557, the SRG component 558 in conjunction with the processor 503 and the modem 565 may be used to perform the methods of block 730.

At block 750, the method 700 may optionally include populating a SRG table with a list of peer AP BSS colors and transmitting the SRG table to the one or more associated STAs as part of a spatial reuse parameter set element. In some examples, the one or more associated STAs may determine whether to enable or disable SR at the STA based on the reception of the SRG information in the spatial reuse parameter set element. Additionally or alternatively, as set forth below, the AP may also determine whether the AP may enable or disable SR based on determination whether one or more neighboring APs are peer APs. Aspects of block 750 may be performed by combination of SRG component 558 and the transceiver 506 described with reference to FIG. 5.

At block 760, the method 700 may include performing one or more operations associated with spatial reuse based on determining whether the at least one of the neighboring APs is the peer AP. In some examples, performing the one or more operations associated with the spatial reuse may include disabling spatial reuse for communication based on determining that the at least one of the neighboring APs is the peer or friendly AP of the AP. In another example, performing the one or more operations associated with the spatial reuse may include enabling spatial reuse for communication based on determining that the at least one of the neighboring APs is not a peer or friendly AP. Additionally, in the instances that the beacon report further includes detected power signals of the at least one of the neighboring APs, the AP may determine whether to enable or disable SR based not only on a determination that the at least one neighboring AP is a peer AP, but also based on determination of whether the detected power signal satisfies a power detected threshold. Specifically, in instances that the at least one of the neighboring APs is determined not to be a peer AP, the AP may further further determine whether the detected power signal regarding the at least one of the neighboring APs satisfies a power detected threshold. In some examples, the AP may enable SR for communication based on determining that the detected power signal is less than the power detected threshold. Conversely, the AP may disable SR for communication based on determining that the detected power signal is greater than the power detected threshold. In one aspect, the spatial reuse component 540, the information processing component 557, the SRG component 558 in conjunction with the processor 503 and the modem 565 may be used to perform the methods of block 740.

In one aspect of the method 700, the beacon request may include a request element and an extended request element. In another aspect of the method 700, the information requested includes one or more of BSS ID, SS ID, signal strength (e.g., RSSI), BSS color, or SR parameter.

In another aspect of the method 700, the method may include performing one or more operations associated with spatial reuse based on the information received includes enabling spatial reuse in response to an indication in the information that the one or more neighboring APs are applying spatial reuse.

In another aspect of the method 700, the method may include performing one or more operations associated with spatial reuse based on the information received includes disabling spatial reuse in response to an indication in the information that the one or more neighboring APs are not applying spatial reuse. In yet another aspect of the method 700, the method may include performing one or more operations associated with spatial reuse based on the information received includes determining whether to apply spatial reuse in response to an indication in the information of a signal strength of one of the one or more neighboring APs. In another aspect of the method 700, the method may include performing one or more operations associated with spatial reuse based on the information received includes determining whether there is a color collision between the AP and one of the one or more neighboring APs based at least in part on the information.

The above solutions have been described in connection, or from the perspective of, WLAN. Other wireless technologies, however, may employ the same or similar mechanisms to increase or adjust the energy detection level in a homogeneous deployment. In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for spatial reuse in wireless communications, comprising:
transmitting, by an access point (AP), a beacon request to one or more associated wireless stations (STAs), the beacon request including a request for information of neighboring APs;
receiving, from the one or more STAs, a beacon report regarding at least one of the neighboring APs, wherein the beacon report includes at least a basic service set (BSS) color information of the at least one of the neighboring APs;
correlating the BSS color information included in the beacon report with one or more unique identifiers associated with a set of peer APs to the AP;
determining whether the at least one of the neighboring APs is a peer AP of the AP based at least in part on correlating the BSS color information with the one or more unique identifiers; and
performing one or more operations associated with spatial reuse based on determining whether the at least one of the neighboring APs is a peer AP of the AP.

2. The method of claim 1, wherein performing the one or more operations associated with the spatial reuse, comprises:
disabling spatial reuse for communication based on determining that the at least one of the neighboring APs is the peer AP.

3. The method of claim 1, wherein performing the one or more operations associated with the spatial reuse, comprises:
enabling spatial reuse for communication based on determining that the at least one of the neighboring APs is not peer AP.

4. The method of claim 1, further comprising:
populating a spatial reuse group (SRG) table with a list of peer AP BSS colors; and
transmitting the SRG table to the one or more associated STAs as part of a spatial reuse parameter set element.

5. The method of claim 1, wherein the beacon report further includes information regarding detected power signal of the at least one of the neighboring APs.

6. The method of claim 5, further comprising:
determining that the at least one of the neighboring APs is not a peer AP; and
determining whether the detected power signal regarding the at least one of the neighboring APs satisfies a power detected threshold.

7. The method of claim 6, further comprising:
enabling spatial reuse for communication based on determining that the detected power signal is less than the power detected threshold.

8. The method of claim 6, further comprising:
disabling spatial reuse for communication based on determining that the detected power signal is greater than the power detected threshold.

9. The method of claim 1, wherein the list of unique identifiers of peer APs stored at the AP is a preconfigured list of media access control address (MAC) addresses of the peer APs.

10. The method of claim 1, wherein the unique identifiers associated with the set of peer APs fails to include corresponding BSS color information for each of APs in the set of SRG APs.

11. An access point (AP) for wireless communications, comprising:
a transceiver;
a memory; and
a processor communicatively coupled to the transceiver and the memory, the processor being configured to:
transmit, by an access point (AP), a beacon request to one or more associated wireless stations (STAs), the beacon request including a request for information of neighboring APs;
receive, from the one or more STAs, a beacon report regarding at least one of the neighboring APs, wherein the beacon report includes at least a basic service set (BSS) color information of the at least one of the neighboring APs;
correlate the BSS color information included in the beacon report with one or more unique identifiers associated with a set of peer APs to the AP;
determine whether the at least one of the neighboring APs is a peer AP of the AP based at least in part on correlating the BSS color information with the one or more unique identifiers; and
perform one or more operations associated with spatial reuse based on determining whether the at least one of the neighboring APs is the peer AP to the AP.

12. The AP of claim 11, wherein the processor being configured to perform the one or more operations associated with the spatial reuse is further configured to:
disable spatial reuse for communication based on determining that the at least one of the neighboring APs is the peer AP.

13. The AP of claim 11, wherein the processor being configured to perform the one or more operations associated with the spatial reuse is further configured to:
enable spatial reuse for communication based on determining that the at least one of the neighboring APs is not peer AP.

14. The AP of claim 11, wherein the processor is further configured to:
populate a spatial reuse group (SRG) table with a list of peer AP BSS colors; and
transmit the SRG table to the one or more associated STAs as part of a spatial reuse parameter set element.

15. The AP of claim 11, wherein the beacon report further includes information regarding detected power signal of the at least one of the neighboring APs.

16. The AP of claim 15, wherein the processor is further configured to:
determine that the at least one of the neighboring APs is not a peer AP; and
determine whether the detected power signal regarding the at least one of the neighboring APs satisfies a power detected threshold.

17. The AP of claim 16, wherein the processor is further configured to:
enable spatial reuse for communication based on determining that the detected power signal is less than the power detected threshold.

18. The AP of claim 16, wherein the processor is further configured to:
disable spatial reuse for communication based on determining that the detected power signal is greater than the power detected threshold.

19. The AP of claim 11, wherein the list of unique identifiers of peer APs stored at the AP is a preconfigured list of media access control address (MAC) addresses of the peer APs.

20. The AP of claim 11, wherein the unique identifiers associated with the set of peer APs fails to include corresponding BSS color information for each of APs in the set of SRG APs.

21. A computer readable medium storing code for wireless communications, the code comprising code for:
transmitting, by an access point (AP), a beacon request to one or more associated wireless stations (STAs), the beacon request including a request for information of neighboring APs;
receiving, from the one or more STAs, a beacon report regarding at least one of the neighboring APs, wherein the beacon report includes at least a basic service set (BSS) color information of the at least one of the neighboring APs;
correlating the BSS color information included in the beacon report with one or more unique identifiers associated with a set of peer APs to the AP;
determining whether the at least one of the neighboring APs is a peer AP of the AP based at least in part on correlating the BSS color information with the one or more unique identifiers; and
performing one or more operations associated with spatial reuse based on determining whether the at least one of the neighboring APs is the peer AP to the AP.

22. The computer readable medium of claim 21, wherein the code for performing the one or more operations associated with the spatial reuse, further comprises code for:
disabling spatial reuse for communication based on determining that the at least one of the neighboring APs is the peer AP.

23. The computer readable medium of claim 22, wherein the code for performing the one or more operations associated with the spatial reuse, further comprises code for:
enabling spatial reuse for communication based on determining that the at least one of the neighboring APs is not peer AP.

24. The computer readable medium of claim 21, further comprises code for:
populating a spatial reuse group (SRG) table with a list of peer AP BSS colors; and
transmitting the SRG table to the one or more associated STAs as part of a spatial reuse parameter set element.

25. The computer readable medium of claim 21, wherein the beacon report further includes information regarding detected power signal of the at least one of the neighboring APs.

26. The computer readable medium of claim 25, further comprising code for:
determining that the at least one of the neighboring APs is not a peer AP; and
determining whether the detected power signal regarding the at least one of the neighboring APs satisfies a power detected threshold.

27. The computer readable medium of claim 26, further comprising code for:
enabling spatial reuse for communication based on determining that the detected power signal is less than the power detected threshold.

28. The computer readable medium of claim 26, further comprising code for:
disabling spatial reuse for communication based on determining that the detected power signal is greater than the power detected threshold.

29. The computer readable medium of claim 21, wherein the list of unique identifiers of peer APs stored at the AP is a preconfigured list of media access control address (MAC) addresses of the peer APs.

30. An apparatus for wireless communications, comprising:
transmitting, by an access point (AP), a beacon request to one or more associated wireless stations (STAs), the beacon request including a request for information of neighboring APs;
receiving, from the one or more STAs, a beacon report regarding at least one of the neighboring APs, wherein the beacon report includes at least a basic service set (BSS) color information of the at least one of the neighboring APs;
correlating the BSS color information included in the beacon report with one or more unique identifiers associated with a set of peer APs to the AP;
determining whether the at least one of the neighboring APs is a peer AP of the AP based at least in part on correlating the BSS color information with the one or more unique identifiers; and
performing one or more operations associated with spatial reuse based on determining whether the at least one of the neighboring APs is the peer AP to the AP.
